(19) United States
(12) Patent Application Publication
(10) Pub. No.: US 2007/0064385 A1
(43) Pub. Date: Mar. 22, 2007

(54) Receiving frame having removable computer drive carrier and fan modules

(76) Inventors: Dieter G. Paul, Anaheim, CA (US); Choon-Tak Tang, Irvine, CA (US)

Correspondence Address: MORLAND C FISCHER, 2030 MAIN ST, SUITE 1050, IRVINE, CA, 92614, US

(21) Appl. No.: 11/229,174

(22) Filed: Sep. 19, 2005

(51) Int. Cl. G06F 1/20; G06F 1/16

(52) U.S. Cl. 361/687; 361/685

(57) ABSTRACT

A (e.g., U-shaped) receiving frame to be mounted in a drive bay or similar enclosure and interfaced with a host computer. The receiving frame receives therewithin a removable computer drive carrier module which encloses a computer drive and a removable fan module which exhausts heat generated by the computer drive to the atmosphere. Should the fan module fail, it is simply and easily removed from the receiving frame to be replaced by a new module, but without affecting the operation of the computer drive module or requiring that the receiving frame be taken out of service. A rotatable handle is pivotally connected across the first end of the computer drive carrier module. When the computer drive module is installed in the receiving frame, the handle is rotated to a closed position by which to cause power to be supplied to the computer drive. When it is desirable to apply a pulling force to the handle in order to remove the computer drive carrier from the receiving frame, the handle is rotated to an open position by which to cause power to be automatically removed from the computer drive.

### BACKGROUND OF THE INVENTION

1. Field of the Invention

This invention relates to a (e.g., U-shaped) receiving frame that is adapted to be interfaced with a host computer and to receive therewithin a removable computer drive carrier module which encloses a computer drive and a removable fan module which exhausts heat generated by the computer drive to the atmosphere. Should the fan module fail, it is simply and easily removed from the receiving frame to be replaced with a new module, but without effecting the operation of the computer drive module or requiring that the receiving frame be taken out of service.

2. Background Art

With the advent of personal computers and workstations, it is often necessary to remove the medium on which computer data is stored. For example, it may be desirable to remove a storage medium so as to be carried to a different site and/or a different computer system. It may also be desirable to remove the storage medium to a secure location when the computer data that is stored therein is particularly sensitive or secret. To accomplish the foregoing, computer storage media (e.g., disc drives) are affixed to carriers that are removably received within a storage enclosure or chassis that is located remotely from a host computer. The removable disc drive carrier is simply pulled out of its chassis on an as needed basis. Either the original disc drive carrier or a different carrier can be returned to the chassis. This insertion/removal cycle of the carrier usually occurs several times throughout the workday. By way of example only, reference may be made to U.S. Pat. No. 6,442,022 issued Aug. 27, 2002 for one example of a removable disc drive carrier.

Because of the heat that is generated by the computer drive that is enclosed by the computer drive carrier, it is important that a fan be provided in proximity to the computer drive to remove such heat and thereby prevent a thermally-induced malfunction. The heat removing fan is typically hardwired to a controller and a power source so as to consume valuable space. Moreover, the fan is known to fail over time and require replacement. Even though the fan is a relatively simple and inexpensive device, because of its being hardwired to an associated controller and power source, the system in which the fan is installed must often be taken out of service so that a new fan can be substituted therefor. In some cases, the system must be returned to the factory for repair. As a consequence of the foregoing, operating time will be wasted and the overall system efficiency will be reduced.

What is even more, in some cases the computer drive can be damaged if the drive carrier is withdrawn from or returned to its chassis with the drive connected to its power supply and still spinning. For example, an incoming computer drive carrier has an electrical connector to receive a supply of power from a source thereof. At the instant that an incoming drive carrier makes electrical contact with its respective connector at a chassis to power the disc drive within the carrier, there is typically a surge of current due to the fact that current is suddenly drawn from the power supply to charge decoupling capacitors that are associated with the computer drive. Such a surge of current during the moment of contact is known to generate an electric spark which may damage the computer drive as a consequence of the sudden rush of current. Moreover, the corresponding high temperature that is generated by the electric spark can damage the computer drive as well as its mating connectors at the drive carrier and the chassis. Likewise, the computer drive could suffer damage if its drive carrier were removed from the chassis with the drive still powered up and spinning. Accordingly, it would be desirable to avoid the problem that is caused by a possible current surge or an electric spark and the resulting damage to the computer drive and its removable carrier by ensuring that power to the computer drive will be interrupted before the computer drive carrier can be removed from and returned to its chassis.

### SUMMARY OF THE INVENTION

In general terms, a U-shaped receiving frame is disclosed that is mounted in a computer drive bay to be interfaced with a host computer. The receiving frame is adapted to slidably receive a removable computer drive carrier module and a removable fan module. The computer drive module encloses a conventional computer (e.g., disc) drive, and the fan module exhausts heat generated by the computer drive to the atmosphere. To this end, the removable drive carrier module and the removable fan module are efficiently stacked one above the other to create a relatively thin space-conserving profile. The removable drive carrier module may be pulled outwardly from the receiving frame and swapped for a different module. Should the fan module fail, it may be simply and easily removed from the receiving frame and replaced with a new module, but without affecting the computer drive or requiring that the receiving frame be taken out of service.

The drive carrier module has a unique rotatable handle associated therewith. One end of the handle is pivotally connected to the front end of the drive carrier module, such that the handle is rotatable between a closed position extending laterally across the front end of the drive carrier module and an open position projecting from the drive carrier module at which a pulling force may be applied to cause the drive carrier module to be removed from its receiving frame. The pivotally connected end of the handle carries a tab which is advanced outwardly from the carrier module when the handle is rotated to the closed position and is retracted inwardly of the carrier module when the handle is rotated to the open position. When the computer drive carrier module is installed in the receiving frame and the handle thereof rotated to the closed position, the outwardly advancing tab is moved through a window that is formed in an adjacent hollow side of the receiving frame and into receipt by an optical sensor that is connected to a circuit board mounted in the hollow side of the frame. With the tab blocking an optical path between an emitter and a detector thereof, the optical sensor is disabled so as to cause power to be supplied to the computer drive. Moreover, the receipt of the tab through the window creates a stop to block the removal of the computer drive carrier module from the receiving frame.

When it is desirable to remove the drive carrier module from the receiving frame, the handle is rotated to the open position. The tab is now withdrawn from the optical path of the optical sensor and retracted inwardly of the drive carrier module via the window formed in the hollow side of the receiving frame. Accordingly, the optical sensor is enabled to cause power to be automatically removed from the computer drive, whereby the computer drive is powered down. A drive status display will be illuminated when the computer drive stops spinning so as to indicate that it is safe to remove the drive and its drive carrier module from the receiving frame.

The removable fan module includes a fan that is located in an air flow path through the drive carrier module by which heat can be carried away from the drive carrier module and exhausted to the atmosphere. Cool ambient air is drawn through air intake openings located at the front end of the drive carrier module. The cool air collects the heat that is emitted by the computer drive, and the resulting warm air is blown to the atmosphere through an air exhaust port that is located at the rear of the receiving frame.

### BRIEF DESCRIPTION OF THE DRAWINGS

FIG. 1 shows a U-shaped receiving frame including a removable computer drive carrier module and a removable fan module received inwardly thereof according to a preferred embodiment of this invention;

FIG. 2 shows the U-shaped receiving frame of FIG. 1 with the top cover and the computer drive removed from the computer drive carrier module;

FIG. 3 shows the U-shaped receiving frame of FIG. 1 with the computer drive carrier module and the fan module removed therefrom;

FIG. 4 shows the computer drive carrier module being removed from (or returned to) its U-shaped receiving frame and having a rotatable handle moved to an open position at which to receive a pulling force;

FIG. 5 shows the computer drive carrier module of FIG. 4 after being removed from its receiving frame with the rotatable handle thereof moved to a closed position;

FIG. 6 shows a circuit board mounted on a side of the receiving frame and having an optical sensor to control the supply of power to the computer drive of the computer drive carrier module in response to a rotation of the handle of the drive carrier module between the opened and closed positions;

FIG. 7 shows an exploded view of electrical connectors on a motherboard to be mated with electrical connectors on the circuit board of FIG. 6, the computer drive carrier module, and the fan module;

FIG. 8 shows the removable fan module removed from its receiving frame and having a rotatable handle moved to an open position at which to receive a pulling force;

FIG. 9 shows a bottom view of the removable fan module of FIG. 8 and having a drive temperature sensor mounted on a circuit board; and

FIG. 10 shows a key controlled locking arm rotated to a locked position at which to prevent a removal of the computer drive carrier module from its receiving frame.

### DESCRIPTION OF THE PREFERRED EMBODIMENT

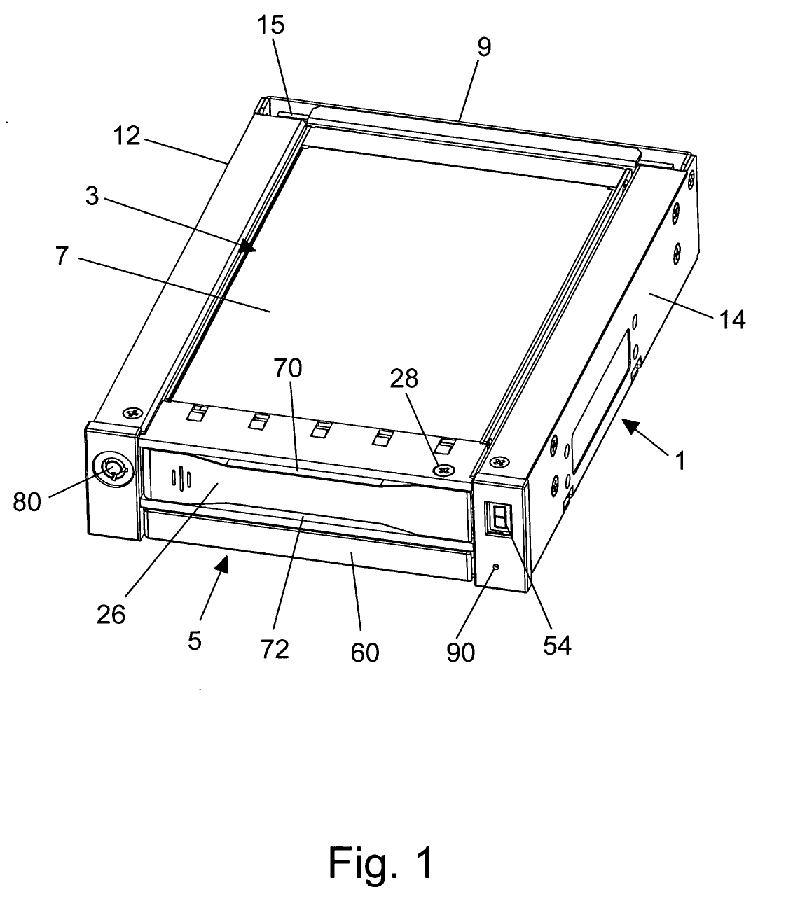

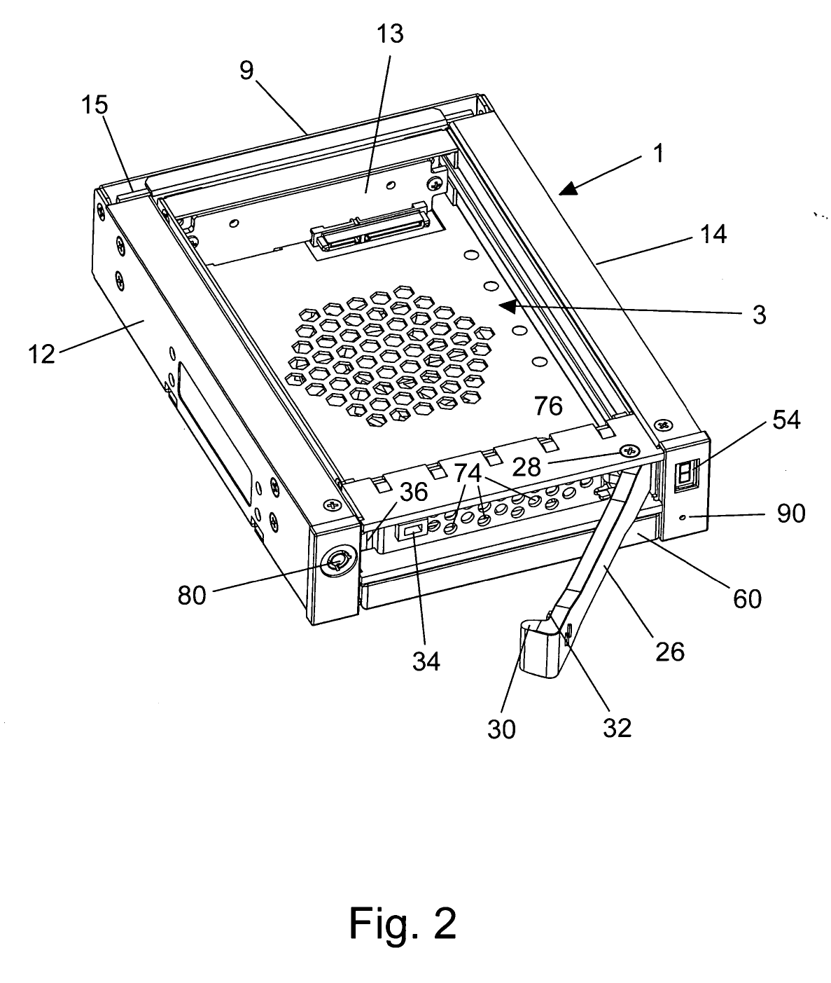

Referring initially to FIGS. 1-7 of the drawings, there is shown a U-shaped receiving frame 1 for receiving therewithin a removable computer drive carrier module 3 and a removable fan module 5. The drive carrier module 3 encloses a standard computer drive (not shown), such as a disk drive, or the like. The U-shaped receiving frame 1 is typically mounted in a computer drive bay or similar enclosure (also not shown) by which the computer drive that is enclosed within drive carrier module 3 can be interfaced with a host computer. In the case of FIGS. 1, 4 and 5, a cover 7 of the drive carrier module 3 is shown positioned over top the computer drive. In the case of FIG. 2, the top cover 7 and the computer drive have been removed from the drive carrier module 3.

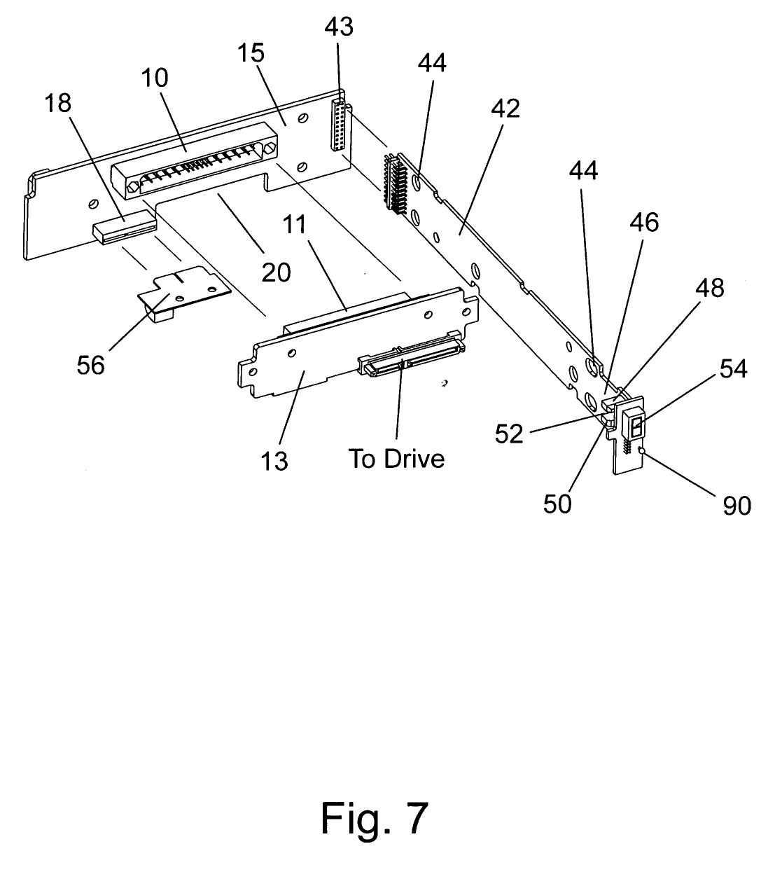

As will be explained in greater detail hereinafter, each of the removable drive carrier module 3 and the removable fan module 5 is slidable into and out of the U-shaped receiving frame 1. As is best shown in FIG. 7 of the drawings, the drive carrier module 3 includes a female electrical connector 11 at the incoming back end 13 thereof. Mounted on a motherboard 15 (also best shown in FIG. 7) at the rear wall 9 of the receiving frame 1 is a complementary male electrical connector 10 which is adapted to be mated to the incoming female connector 11 at the back end 13 of the drive carrier module 3 by which power, data and control signals can be provided to the computer drive. The motherboard 15 carries display control and I/O logic to interface receiving frame 1 with its host computer. Each of the female connector 11 at the incoming back end 13 of the drive carrier module 3 and the male connector 10 on the motherboard 15 at the rear wall 9 of frame 1 is preferably characterized by high speed (e.g., capable of data rates of 10 Gbps) and the ability to be subjected to a high number of insertion/extraction cycles (at least 100,000). As an important advantage of the present invention, either one or both of the drive carrier module 3 and the fan module 5 can be slidably removed from the receiving frame 1 and replaced with a new or a different module without requiring that the receiving frame be taken out of service or face a prolonged interruption of service.

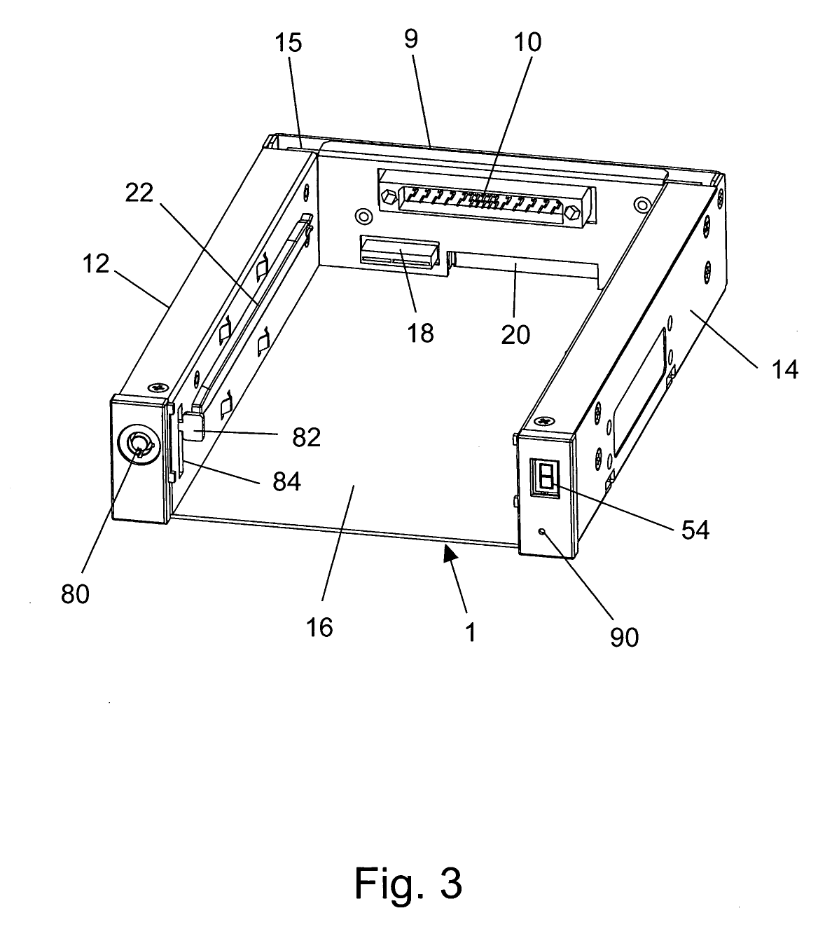

The U-shaped receiving frame 1 is shown in FIG. 3 empty and with the drive carrier module 3 and the fan module 5 removed therefrom. The U-shaped receiving frame 1 includes the aforementioned rear wall 9 and an opposite open front through which the drive carrier and fan modules 3 and 5 are inserted and removed. The motherboard 15 is secured inside rear wall 9 at which to support the electrical connector 10. A pair of parallel aligned, hollow sides 12 and 14 extend between the open front and rear wall 9 of receiving frame 1. A flat slide plate 16 extends across the bottom of the receiving frame 1 below the rear wall 9 and opposite sides 12 and 14.

To complete the fully installed receiving frame 1 as shown in FIG. 1, the fan module 5 is initially pushed past the open front of the receiving frame 1. The fan module 5 slides inwardly through the receiving frame 1 and across the bottom slide plate 16 (of FIG. 3). An electrical connector (designated 56 in FIGS. 7-9) at the back end of fan module 5 is moved into mating engagement with a complementary power and temperature sensor connector 18 (best shown in FIGS. 3 and 7) that is mounted on the motherboard 15 at the rear wall 9 of receiving frame 1 so that power can be supplied to the fan module. A fan air exhaust port 20 (also best shown in FIGS. 3 and 7) is formed through the motherboard 15 and rear wall 9 of receiving frame 1 so that heat which is emitted by the drive carrier module 3 can be blown by fan module 5 to the atmosphere.

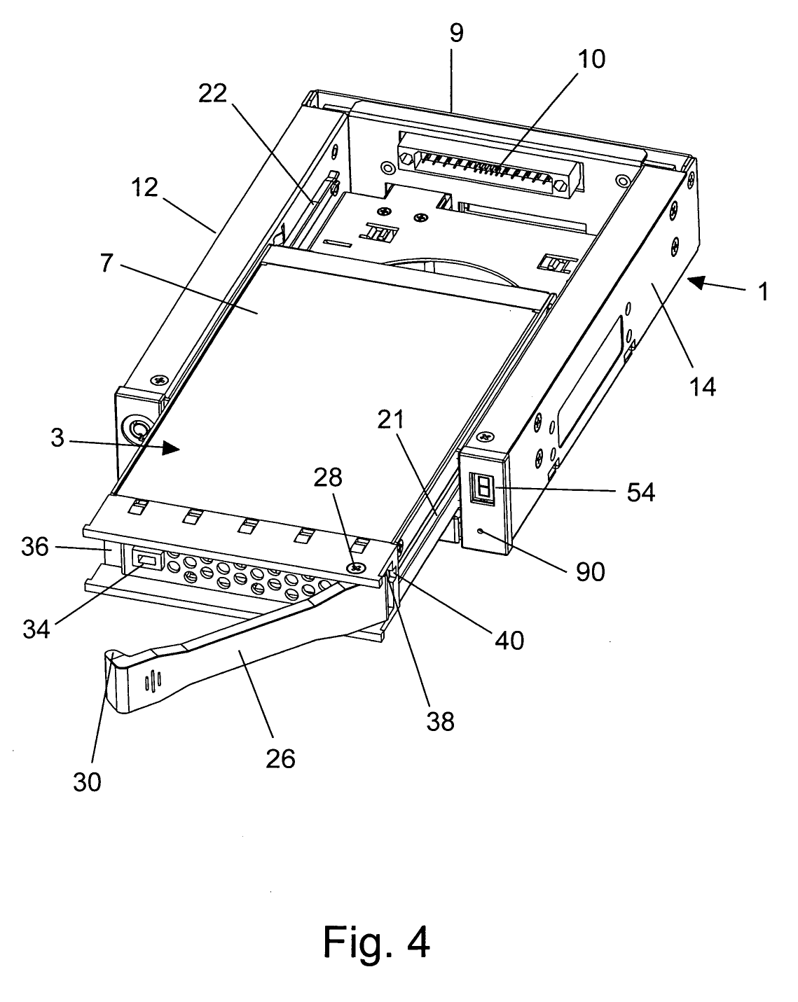

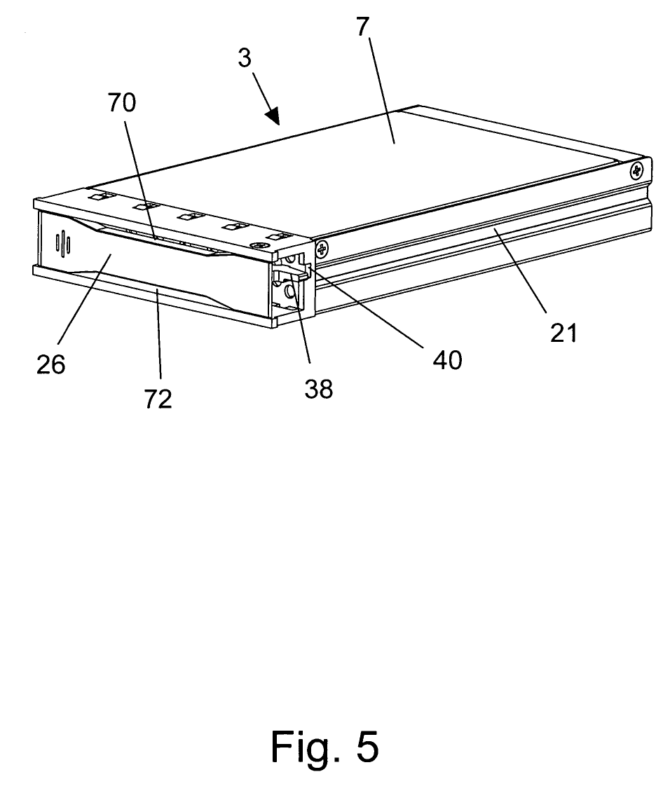

Like the fan module 5, and as illustrated in FIG. 4, the drive carrier module 3 is also pushed past the open front of the receiving frame 1. The drive carrier module 3 slides inwardly through the receiving frame 1 and along the top of the fan module 5. To this end, a pair of guide rails 22 (only one of which being visible in FIG. 4) extend along the opposite sides 12 and 14 of frame 1 to be mated to respective guide channels (designated 21 in FIGS. 4 and 5) of the drive carrier module 3 to help guide the incoming drive carrier module 3 towards the rear wall 9 of receiving frame 1 where the high speed, high insertion cycle female connector (designated 11 in FIG. 7) at the incoming back end 13 of drive carrier module 3 is moved into mating engagement with the opposing high speed, high insertion cycle male connector 10 on the motherboard 15 at rear wall 9.

Turning specifically to FIGS. 1 and 2, the drive carrier module 3 is provided with a unique handle 26 that is adapted to automatically cause the computer drive that is enclosed by carrier module 3 to power down when the handle 26 is manipulated to remove carrier module 3 from the U-shaped receiving frame 1. More particularly, the handle 26 is manually accessible at the open front of the U-shaped receiving frame 1. A first end of the handle 26 is pivotally connected to the front end of drive carrier module 3 by means of a spring-wound fastener 28 so that the handle 26 is rotatable from a closed position (as shown in FIG. 1) extending laterally across the front end of the drive carrier module 3 when the module 3 is located inwardly of the U-shaped receiving frame 1 to an open position (as shown in FIG. 2) rotated away from the front end of the drive carrier module 3 when the module 3 is ready to be pulled out and removed from receiving frame 1.

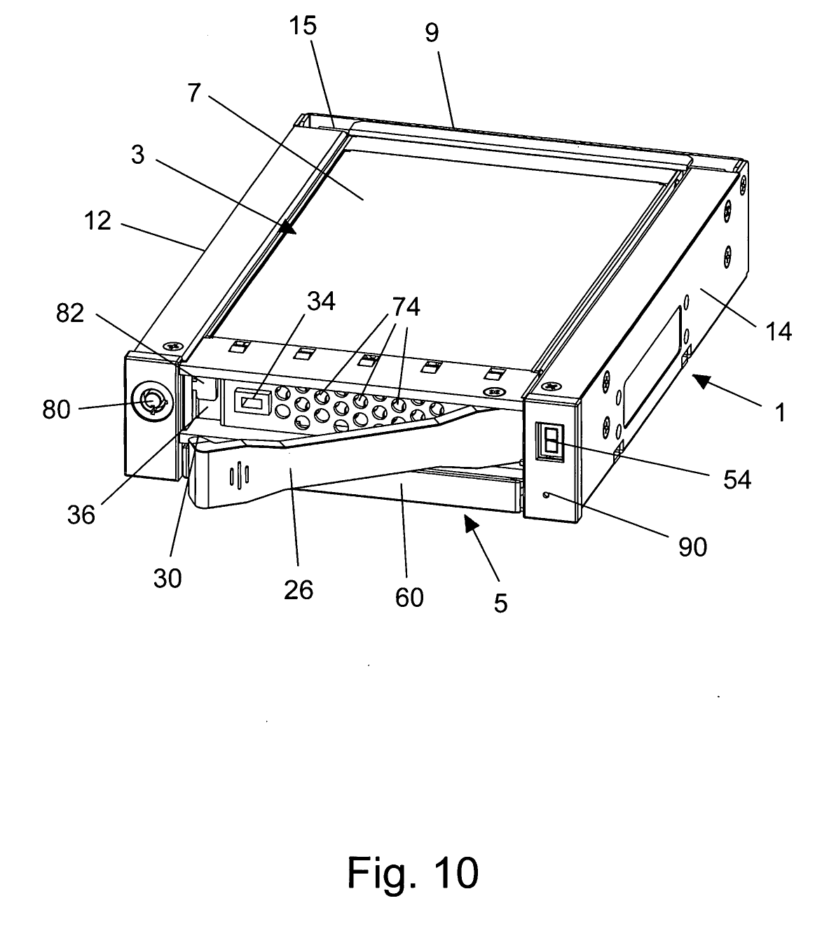

The opposite free end of handle 26 includes a rearwardly extending projection 30. Located at the inside of handle 26 adjacent the projection 30 is a locking nub 32 (best shown in FIG. 2). When the handle 26 is rotated from the open position to the closed position, the locking nub 32 is correspondingly rotated into receipt of and captured by a spring-loaded catch 34 that is positioned at the front end of the drive carrier module 3. At the same time that the locking nub 32 is moved into receipt by the spring-loaded catch 34 as handle 26 is rotated to the closed position, the projection 30 at the free end of handle 26 is rotated into a lock housing 36 (best shown in FIG. 2). As will be explained hereinafter while referring to FIG. 10, the end projection 30 cooperates with a locking system of the U-shaped receiving frame 1 to prevent the unauthorized removal of the drive carrier module 3 from the receiving frame 1.

With the locking nub 32 captured by the spring-loaded catch 34, the handle 26 will be retained in the closed position of FIG. 1 extending laterally across the front end of the drive carrier module 3. When it is desirable to remove the drive carrier module 3 from its receiving frame 1, an inward pushing force is momentarily applied to the handle 26 by which to cause the end projection 30 thereof to move into lock housing 36. The locking nub 32 carried by handle 26 is correspondingly moved against the spring loaded catch 34 so as to cause the locking nub 32 to be released by and ejected from the spring-loaded catch 34 whereby the handle 26 will rotate to the open position of FIG. 2 around the spring-wound fastener 28. A pulling force may now be applied to the handle 26 to cause the drive carrier module 3 to slide outwardly from its receiving frame 1.

FIG. 4 of the drawings shows the handle 26 rotated to the open position during which the drive carrier module 3 can be pulled outwardly from or returned to its U-shaped receiving frame 1. Also shown in FIG. 4 is a tab 38 which is carried by the pivotally connected first end of the handle 26 of drive carrier module 3. The tab 38 is rotatable with the handle 26 as the handle rotates around the fastener 28 to which the first end thereof is pivotally connected.

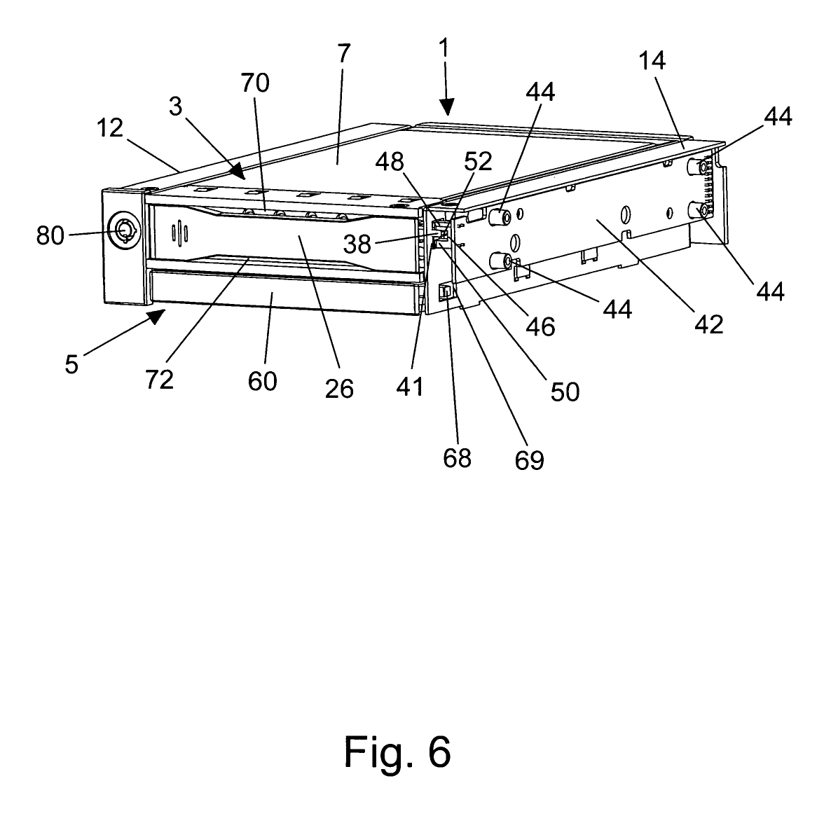

With the handle 26 rotated to the open position so that the drive carrier module 3 can be pulled outwardly from or returned to its U-shaped receiving frame 1 in the manner shown in FIG. 4, the tab 38 of handle 26 will be pulled inwardly of and retracted through a notch 40 located at the front end of carrier module 3. In its retracted position shown in FIG. 4, the tab 38 will be unable to block the movement of carrier module 3 outwardly from its receiving frame 1 in response to a pulling force applied to handle 26. However, when the handle 26 is rotated in an opposite direction to the closed position as shown in FIG. 5, after the drive carrier module 3 has first been pushed inwardly through receiving frame 1 to be installed therewithin in the manner shown in FIG. 1, the tab 38 is correspondingly advanced outwardly from notch 40 at the front end of carrier module 3. In its outwardly projecting position shown in FIG. 5, the tab 38 will be received through an open window (designated 41 in FIG. 6) that is formed in the adjacent hollow side 14 of receiving frame 1 to create a stop by which to prevent the carrier module 3 from being pulled outwardly from frame 1.

The tab 38 performs another important function when it is advanced outwardly from the notch 40 (of FIG. 5) at the front end of the drive carrier module 3 for receipt by the open window 41 (of FIG. 6) in the side 14 of frame 1 in response to a rotation of handle 26 to the closed position. Turning specifically in this regard to FIGS. 6 and 7, there is shown an elongated printed circuit board 42. Printed circuit board 42 is sized to run longitudinally through the hollow side 14 of the U-shaped receiving frame 1 to be mated to an electrical connector 43 on the motherboard 15. The printed circuit board 42 includes mounting holes 44 to enable the printed circuit board 42 to be retained within the hollow side 14. Located at one end of printed circuit board 42 is an optical sensor 46 (best shown in FIG. 7) having an optical emitter 48 (e.g., an infrared emitting diode) and an optical detector 50 (e.g., a phototransistor) that are aligned parallel with one another and separated by a small gap 52. Optical sensor 46 is, for example, Part No. OPB610 manufactured by Optek or an equivalent thereof. However, it is to be understood that a suitable contact-type switch may be substituted for the optical sensor 46. The printed circuit board 42 is mounted within the hollow side 14 of receiving frame 1 so that the optical sensor 46 will be aligned with the window 41 in the side 14 to receive the outwardly projecting tab 38 of handle 26 within the gap 52 between the emitter and detector 48 and 50 of the optical sensor 46 to control the power to the computer drive enclosed by drive carrier module 3 and the operation of a drive status display 54 that is carried by circuit board 42 and visible at the front of side 14.

More particularly, when the handle 26 at the front of the drive carrier module 3 is rotated to the closed position after module 3 has been installed in its receiving frame 1 in the manner shown in FIG. 6, the tab 38 at the pivotally connected end of handle 26 is advanced so as to project outwardly from the notch 40 (best shown in FIG. 5) for receipt through the window 41 of FIG. 6 in the adjacent hollow side 14 of frame 1. The tab 38 is moved through window 41 and into the gap 52 between the parallel aligned emitter and detector 48 and 50 of the optical sensor 46 on the printed circuit board 42 mounted within the side 14 of frame 1. An optical path between the emitter and detector 48 and 50 is thereby interrupted by the presence of tab 38 and the optical sensor 46 is disabled, whereby to cause power to be supplied to the computer drive of drive carrier module 3. At the same time, the drive status display 54 will indicate that the computer drive is being powered up for operation. By way of example, display 54 will initially begin to flash when power is first supplied to the computer drive and then stay fully illuminated when the drive has fully powered up and is ready for use.

When it is desirable to remove the drive carrier module 3 from its receiving frame 1 and the handle 26 of module 3 is rotated to the open position (of FIG. 4), the tab 38 at the pivotally connected end of handle 26 is correspondingly retracted inwardly of module 3 via the window 41 of FIG. 6 in the side 14 of frame 1 so as to move out of the gap 52 between the emitter and detector 48 and 50 of optical sensor 46. An optical path between the emitter and detector 48 and 50 is thereby established, the optical sensor 46 is now enabled, and power will be removed from the computer drive. The drive status display 54 will initially begin to flash and then stay fully illuminated to alert users when the computer drive enclosed by drive carrier module 3 has finally powered down and stopped spinning at which time it will be safe to remove module 3 from its receiving frame 1.

It may be appreciated that the drive carrier module 3 cannot be reconnected to its receiving frame 1 (at connector 10) unless the handle 26 thereof is in the open position of FIG. 4, whereby the computer drive will still be disconnected from its source of power. That is, with the handle 26 in the open position, the tab 38 will be retracted inwardly of the notch 40 so as to be unable to strike frame 1 and impede the drive carrier module 3 from sliding through the open front of receiving frame 1 toward the rear wall 9. Thus, power cannot be restored to the computer drive until the drive module 3 has first been completely reinstalled in the frame 1 and the handle 26 of drive module 3 is once again rotated to the closed position (of FIG. 5).

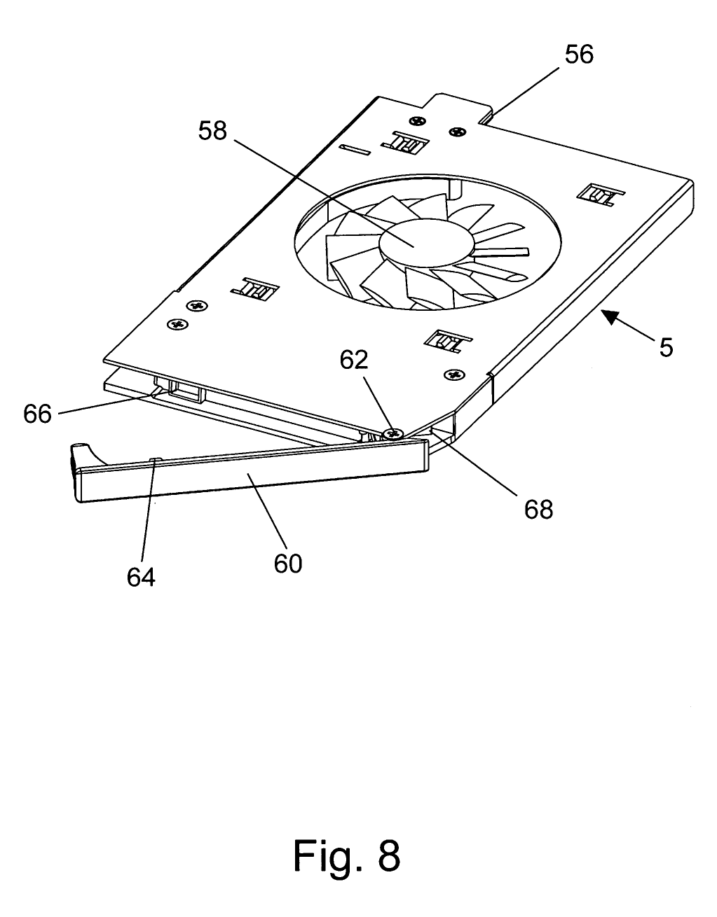

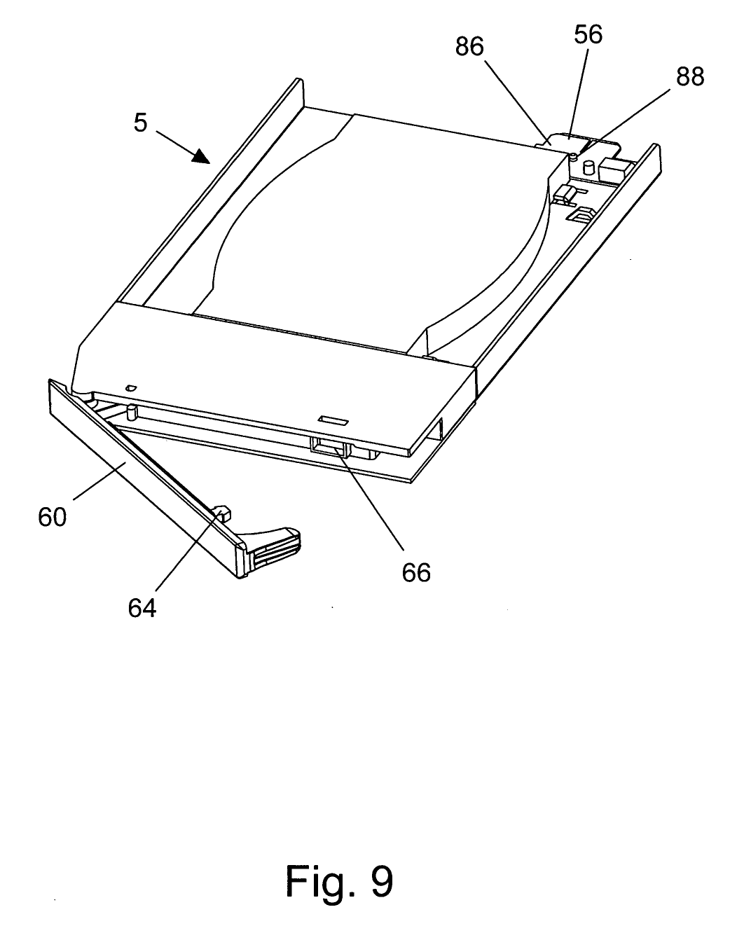

Turning now to FIGS. 8 and 9 of the drawings, details are provided of the removable fan module 5 which, as earlier described, is capable of sliding along the flat slide plate 16 at the bottom of the U-shaped receiving frame 1 shown in FIG. 3. In the installed relationship (of FIG. 1), with the drive carrier module 3 and the fan module 5 located against the rear wall 9 of receiving frame 1, the fan module 5 will lie below the drive carrier module 3. In this position, the fan module 5 is adapted to draw hot air away from the drive carrier module 3 to be expelled to the atmosphere along a soon-to-be described air flow path. As previously described, when the fan module 5 is installed in its receiving frame 1, an electrical connector 56 at the rear of module 5 is moved into mating engagement with the complementary fan power and temperature sensor connector (designated 18 in FIGS. 3 and 7) on the motherboard 15 at the rear wall 9 of receiving frame 1 to enable the fan module 5 to receive power.

The fan module 5 contains a conventional fan 58, having a capacity necessary to blow the heat that is suctioned away from carrier module 3 to the atmosphere via the fan exhaust port (designated 20 in FIGS. 3 and 7) through the motherboard 15 and the rear wall 9 of receiving frame 1. To conserve space and facilitate a compact assembly, the fan module 5 is relatively thin compared with the drive carrier module 3 which encloses the computer drive. By way of example only, the fan module 5 is about 1 cm high, while carrier module 3 is about 27 mm high.

Like the handle 26 of the drive carrier module 3, the fan module 5 also has a rotating handle 60 that is manually accessible at the open front of the U-shaped receiving frame 1. A first end of handle 60 is pivotally connected to the front end of fan module 5 by means of a spring-wound fastener 62 so that handle 60 is rotatable from a closed position (as shown in FIG. 6) extending laterally across the front end of the fan module 5 when the fan module is installed within its receiving frame 1 to an open position as shown in FIGS. 8 and 9 rotated away from the front end of the fan module 5 when the fan module is ready to be pulled outwardly and removed from receiving frame 1.

The opposite free end of handle 60 includes a rearwardly extending locking nub 64. When the handle 60 is rotated from the open position to the closed position, the locking nub 64 is correspondingly rotated into receipt by a spring-loaded catch 66 that is positioned at the front end of the fan module 5. With the locking nub 64 captured by the spring-loaded catch 66, the handle 60 will be retained in the closed position of FIG. 6 extending across the front end of the fan module. When it is desirable to remove the fan module 5 from its receiving frame 1, an inward pushing force is momentarily applied to the handle 60 by which to cause the locking nub 64 thereof to be released and ejected from the spring-loaded catch 66. Accordingly, the handle 60 will rotate to the open position of FIGS. 8 and 9 around spring-wound fastener 62 at which a pulling force may be applied to cause the fan module 5 to slide outwardly from (or return to) its receiving frame 1. Thus, a defective fan module 5 may now be simply and conveniently removed from receiving frame 1 to be replaced by a new module, but without affecting the operation of the computer drive carrier module 3 or requiring that the receiving frame 1 be taken out of service.

Also like the handle 26 of the drive carrier module 3, and as is best shown in FIG. 8, the pivotally connected first end of the handle 60 of fan module 5 includes a tab 68 that is rotatable with the handle 60 as it rotates around the fastener 62 to which the first end thereof is connected. When the handle 60 is rotated to the open position as shown in FIG. 8 so that the fan module 5 can be pulled outwardly from its U-shaped receiving frame 1, the tab 68 of handle 60 is pulled inwardly and retracted inside the front end of fan module 5. In its retracted position, the tab 68 will be unable to block the movement of the fan module 5 outwardly from receiving frame 1 in response to a pulling force applied to the handle 60 once the handle is rotated to the open position.

However, when the fan module 5 is installed in its receiving frame 1 and the handle 60 is rotated in an opposite direction to the closed position as shown in FIG. 6, the tab 68 is correspondingly advanced outwardly from the fan module 5 for receipt through an open window 69 that is formed in the adjacent hollow side 14 of receiving frame 1 by which to create a stop. With the handle 60 rotated to the closed position and the tab 68 rotated for receipt through the window 69, the fan module 5 cannot be pulled outwardly from the frame 1 because the tab 68 will now block the removal thereof.

As disclosed above, the removable fan module 5 is located within the U-shaped receiving frame 1 below the removable drive carrier module 3 so that heat can be drawn away from the drive carrier module 3 to be exhausted to the atmosphere by way of an air flow path through the receiving frame 1. More particularly, and referring once again to FIG. 1, the handle 26, which is shown rotated to the closed position across the front end of the drive carrier module 3 at which to cause power to be supplied to the computer drive, has upper and lower narrowed sections by which to establish air intake passages 70 and 72. As is best shown in FIG. 2, the air intake passages 70 and 72 around handle 26 communicate with a plurality of air intake ports 74. As is also best shown in FIG. 2, the air intake ports 74 at the front end of the drive carrier module 3 communicate with throughholes 76 formed in the bottom of the drive carrier module upon which the computer drive is seated.

Inasmuch as the fan module 5 lies below the drive carrier module 3, cool ambient air from outside the U-shaped receiving frame 1 is drawn into the drive carrier module 3 via air intake passages 70 and 72 and the air intake ports 74. The heat emitted by the computer drive is transferred to the cool intake air, whereby the resulting warm air is blown by the fan 58 of fan module 5 to the atmosphere via throughholes 76 at the bottom of the drive carrier module 5 and the fan air exhaust port (designated 20 in FIGS. 3 and 7) that is formed through the motherboard 15 and the rear wall 9 of receiving frame 1.

Accordingly, it can now be appreciated that the compact drive carrier module 3 and the fan module 5 are efficiently stacked one above the other in a single receiving frame 1 through which an air flow path is created to enable the computer drive that is enclosed by drive carrier module 3 to be cooled by ambient fan driven air. As earlier indicated, should the fan module 5 fail and require replacement, it is simply removed from its receiving frame 1 so that a new fan module can be quickly substituted therefor. In order to avoid possible damage to the computer drive when the drive carrier module is either removed from the receiving frame 1 (to be swapped for a different module) or later returned to frame 1, the handle 26 of the module must be rotated to the open position to cause power to be automatically removed from the drive and a drive status display 54 to be illuminated. In this same regard, power cannot be restored to the same or a different computer drive module 3 until such module has first been completely installed in the receiving frame 1 and the handle 26 thereof has then been rotated to the closed position.

In order to conserve energy as well as increase life expectancy, the fan 58 of fan module 5 of FIG. 8 will be disabled whenever the drive carrier module 3 is removed from the receiving frame 1. To this end, one pin of the male connector 10 on the motherboard 15 at the rear wall 9 of receiving frame 1 is responsive to the disconnection therefrom of the female connector 11 at the back wall 13 of drive carrier module 3 of FIG. 7 when the drive carrier module 3 is removed from frame 1. In this case, power will be automatically removed from the fan module 5 until the drive carrier module 3 is returned to frame 1 and connector 11 is once again mated to connector 10.

As indicated above when referring to FIGS. 8 and 9, the fan module 5 has an electrical connector 56 that is adapted to be mated to a power and temperature sensor connector 18 in the motherboard 15 at the rear wall 9 of receiving frame 1. When the drive carrier module 3 and the fan module 5 are completely installed in their receiving frame 1 and the connector 56 of fan module 5 is received by the power and temperature sensor connector 18, the fan 58 of fan module 5 will be powered in order to draw warm air away from the computer drive to be exhausted to the atmosphere by way of the fan air exhaust port 20 through motherboard 15 and the rear wall 9 of carrier module 3. As is best shown in FIG. 9, the connector 56 of fan module 5 is mounted on a printed circuit board 86 that is affixed to the bottom of the fan module 5. A drive temperature sensor 88 (e.g., a thermistor, or the like) is connected to circuit board 86. The drive temperature sensor 88 is positioned within the receiving frame 1 so as to be able to monitor the temperature of the computer drive within the computer drive carrier module 3. According to one embodiment, the drive temperature sensor 88 will supply an output signal to the motherboard 15 by which to initiate an alarm should the operating temperature of the computer drive exceed a particular pre-determined temperature.

An ambient temperature sensor 90 (best shown in FIGS. 1-4) is located on the circuit board 42 of FIG. 7 so as to communicate with the atmosphere at the front of the hollow side 14 of the drive carrier module 3 in order to be responsive to the temperature of the ambient air that surrounds the receiving frame 1. The ambient temperature sensor 90 provides a reference temperature to be compared against the temperature of the computer drive to which the drive temperature sensor 88 (of FIG. 9) is responsive. According to an alternate embodiment, should the temperature detected by the drive temperature sensor 88 exceed the reference temperature (i.e., the ambient air temperature) detected by the ambient temperature sensor 90 by a particular pre-determined amount, then the drive temperature sensor 88 supplies an output signal to the motherboard 15 by which to initiate an alarm and thereby indicate that the computer drive may be running hot and at a potentially destructive temperature. The alarms generated during the first and alternate embodiments may be audible and/or visual so as to call attention to the high temperature operating condition of the computer drive.

Referring now to FIG. 10 of the drawings, there is shown a key operated lock 80 that is accessible at the hollow side 12 of U-shaped receiving frame 1. A key (not shown) inserted and rotated in lock 80 controls the corresponding rotational movement of a locking arm 82. The locking arm 82 is shown in FIG. 10 rotated to a locked position projecting outwardly from the side 12 of frame 1 through a slot (designated 84 in FIG. 3) that is formed in side 12. However, a rotation of the key in the lock 80 in an opposite direction will cause a corresponding rotation of the locking arm 82 so as to be retracted inwardly of the side 12. With the drive carrier module 3 and the fan module 5 installed in receiving frame 1 in the manner shown in FIG. 10 and the locking arm 82 rotated to the locked position, the locking arm 82 will extend across and block the lock housing 36 at the front end of the drive carrier module 3 in which the inward projection 30 of handle 26 is received so as to prevent a removal of module 3 from its receiving frame 1 until locking arm 82 is first rotated to the unlocked position.

As previously described, when it is desirable to remove the drive carrier module 3 from receiving frame 1, an inward pushing force is momentarily applied to the handle 26 by which to cause the end projection 30 of handle 26 to move into the lock housing 36 and thereby cause the locking nub 32 (of FIG. 2) that is carried by handle 26 to be released by and ejected from the spring-loaded catch 34 at the front of module 3. Following a release of locking nub 32, the handle 26 will automatically rotate from the closed position of FIG. 1 to the open position of FIG. 2 at which to receive an outward pulling force. However, with the locking arm 82 of lock 80 rotated to the locked position as shown in FIG. 10, the projection 30 of the handle 26 will begin to move through lock housing 36 and then strike the locking arm 82 which extends thereacross when the inward pushing force is momentarily applied to handle 26. The engagement of locking arm 82 by the handle end projection 30 will prevent any further inward movement of the projection 30 into lock housing 36 and thereby block the inward movement of the locking nub 32 carried by arm 26 towards the spring-loaded catch 34. Therefore, the locking nub 32 cannot be ejected from the catch 34, the arm 26 of the drive carrier module 3 cannot rotate from the closed position to the open position, and the drive carrier module 3 cannot be removed from its receiving frame 1.

In other words, rotating the locking arm 82 to the locked position across the lock housing 36 as shown in FIG. 10 prevents a removal of the drive carrier module 3 from receiving frame 1. The foregoing is accomplished by the locking arm 82 blocking the inward movement of the end projection 30 of handle 26 inwardly through lock housing 36 when the handle 26 is first pushed inwardly in an effort to correspondingly move locking nub 32 towards the spring-loaded catch 34 to cause the release of locking nub 32 from catch 34 to cause handle 26 to rotate to the open position at which to receive an outward pulling force.

We claim:

1. A combination, comprising:
a receiving frame to be interfaced with a computer and having a first connector, a second connector, and an air exhaust opening;
a computer drive carrier for enclosing a computer drive on which data is stored, said computer drive carrier received by said receiving frame to be connected to said first power connector thereof by which power and data are supplied to said computer drive, said computer drive carrier being removable from said receiving frame; and
a fan carrier having a fan, said fan carrier received by said receiving frame to be connected to said second connector thereof by which power is supplied to said fan, said fan carrier located within said receiving frame relative to said computer drive carrier so that said fan blows heat emitted by the computer drive of said computer drive carrier to the atmosphere via said air exhaust opening, said fan carrier also being removable from said receiving frame.

2. The combination recited in claim 1, wherein said computer drive carrier is disposed within said receiving frame so as to be positioned above said fan carrier.

3. The combination recited in claim 1, wherein said receiving frame also has an open front, each of said removable computer drive carrier and said removable fan carrier being slidable inwardly and outwardly of said receiving frame by way of said open front.

4. The combination recited in claim 1, wherein said computer drive carrier has an air intake opening formed therein, the fan of said fan carrier drawing ambient air into said receiving frame via said air intake opening to collect the heat emitted by the computer drive and blowing the heated air out of said receiving frame to the atmosphere via said air exhaust opening.

5. The combination recited in claim 1, wherein said computer drive carrier includes a handle being movable between open and closed positions, said handle being moved to the closed position when said computer drive carrier is received by said receiving frame whereby power is supplied to the computer drive from the first connector of said receiving frame, and said handle being moved to the open position when said computer drive carrier is to be removed from said receiving frame whereby power is removed from the computer d rive.

6. The combination recited in claim 5, wherein said receiving frame also has a computer drive status indicator to provide a signal after the handle of said computer drive carrier has been moved to the open position and power has been removed from the computer drive.

7. The combination recited in claim 5, wherein said receiving frame also has a locking arm movable to a locked position at which to engage the handle of said computer drive carrier to prevent said handle from moving from the closed position to the open position by which to correspondingly prevent said computer drive carrier from being removed from said receiving frame.

8. The combination recited in claim 5, wherein said receiving frame also has switch means that is responsive to the position of the handle of said computer drive carrier, said switch means being operable to cause power to be supplied to the computer drive of said computer drive carrier when said handle is in the closed position and to cause power to be removed from the computer drive when said handle is in the open position.

9. The combination recited in claim 8, wherein said switch means is an optical sensor.

10. The combination recited in claim 9, wherein said optical sensor has an optical emitter, an optical detector spaced from said optical emitter, and an optical path extending therebetween, said handle being moved to the closed position at which to block the optical path of said optical sensor and thereby enable power to be supplied to the computer drive of said computer drive carrier, and said handle being moved to the open position so as to unblock said optical path and thereby enable power to be removed from the computer drive.

11. The combination recited in claim 10, wherein said handle has a tab projecting therefrom, said tab moving with said handle so that when said handle is moved to the closed position, said tab is correspondingly moved between the optical emitter and the optical detector of said optical sensor to block said optical path thereof, and when said handle is moved to the open position, said tab is correspondingly moved relative to the optical emitter and the optical detector so as to unblock said optical path.

12. The combination recited in claim 11, wherein said receiving frame also has at least one side along which said computer drive carrier is moved, said optical sensor being positioned at said one side so as to receive the tab projecting from said handle in the optical path between the optical emitter and the optical detector of said optical sensor when said handle is moved to the closed position.

13. The combination recited in claim 12, wherein the at least one side of said receiving frame has an open window formed therein, said optical sensor being located in alignment with said open window so that the tab projecting from the handle of said computer drive carrier is moved through said window and into the optical path of said optical sensor when said handle is rotated to the closed position, the receipt of said tab through said window forming a stop and blocking the removal of said computer drive carrier from said receiving frame.

14. The combination recited in claim 1, wherein said first power connector of said receiving frame is responsive to the removal of said computer drive carrier from said receiving frame by which to cause an interruption in the power being supplied to said fan carrier.

15. The combination recited in claim 1, further comprising a drive temperature sensor positioned to monitor the operating temperature of the computer drive of said computer drive carrier, said drive temperature sensor generating an alarm signal in the event that the operating temperature of the computer drive exceeds a particular predetermined temperature.

16. The combination recited in claim 15, further comprising an ambient temperature sensor positioned to monitor the air temperature surrounding said receiving frame, the operating temperature sensed by said drive temperature sensor being compared to the air temperature sensed by said ambient temperature sensor for causing said alarm signal to be generated in the event that the difference between the air and operating temperatures is greater than a particular predetermined amount.

17. The combination recited in claim 16, wherein said drive temperature sensor is positioned on said fan carrier and said ambient temperature sensor is positioned on said receiving frame.

18. The combination recited in claim 1, wherein said fan carrier includes a handle being movable between open and closed positions, said handle being moved to the closed position when said fan carrier is received by said receiving frame whereby power is supplied to the fan of said fan carrier from the second connector of said receiving frame, and said handle being moved to the open position when said fan carrier is to be removed from said receiving frame whereby power is removed from the fan.

19. The combination recited in claim 18, wherein said receiving frame has an opening formed therein and the handle of said fan carrier has a tab projecting therefrom and movable therewith, so that when said handle is moved to the closed position, said tab is correspondingly moved through said opening, the receipt of said tab through said opening forming a stop and thereby blocking the removal of said fan module from said receiving frame.

20. The combination recited in claim 1, wherein each of said first and second connectors of said receiving frame is a high speed, high insertion cycle connector.

21. A combination, comprising:
a receiving frame to be interfaced with a computer and having a first connector, a second connector, and an air exhaust opening;
a computer drive carrier for enclosing a computer drive on which data is stored, said computer drive carrier received by said receiving frame to be connected to said first connector thereof by which power and data are supplied to said computer drive, said computer drive carrier being removable from said receiving frame;
a computer drive carrier handle being movable between open and closed positions, said computer drive carrier handle being moved to the closed position when said computer drive carrier is received by said receiving frame whereby power is supplied to the computer drive from the first connector of said receiving frame, and said computer drive carrier handle being moved to the open position when said computer drive carrier is to be removed from said receiving frame whereby power is removed from the computer drive;
a fan carrier having a fan, said fan carrier received by said receiving frame to be connected to said second connector thereof by which power is supplied to said fan, said fan carrier located within said receiving frame relative to said computer drive carrier so that said fan blows heat emitted by the computer drive of said computer drive carrier to the atmosphere via said air exhaust opening, said fan carrier also being removable from said receiving frame; and
a fan carrier handle being movable between open and closed positions, said fan carrier handle being moved to the closed position when said fan carrier is received by said receiving frame whereby power is supplied to the fan of said fan carrier from the second connector of said receiving frame, and said fan carrier handle being moved to the open position when said fan carrier is to be removed from said receiving frame whereby power is removed from the fan.
